(19) United States
(12) Patent Application Publication
(10) Pub. No.: US 2025/0047398 A1
(43) Pub. Date: Feb. 6, 2025

(54) MEASUREMENT ACCURACY REQUIREMENT FOR AI/ML BEAM PREDICTION WITH TESTABILITY

(71) Applicant: Nokia Technologies Oy, Espoo (FI)

(72) Inventors: Tachporn SANGUANPUAK, Oulu (FI); Fahad SYED MUHAMMAD, Massy (FR); Frederick VOOK, Naperville, IL (US); Amir Mehdi AHMADIAN TEHRANI, Munich (DE); Andrea BONFANTE, Massy (FR); Dimitri GOLD, Espoo (FI)

(21) Appl. No.: 18/761,656

(22) Filed: Jul. 2, 2024

Related U.S. Application Data
(60) Provisional application No. 63/530,134, filed on Aug. 1, 2023.

(51) Int. Cl. H04B 17/373; H04B 17/382

(52) U.S. Cl. CPC H04B 17/373; H04B 17/382

(57) ABSTRACT

The present document provides for performing measurements for beam management. According to an aspect, a method comprises: determining a mode for beam management, based on a configuration that indicates the mode for beam management; switching to the mode for beam management; performing at least one measurement related to artificial intelligence or machine learning beam management, while operating in the mode for beam management; and transmitting the at least one measurement to a test equipment or a network.

### TECHNICAL FIELD

The examples and non-limiting example embodiments relate generally to communications and, more particularly, to a measurement accuracy requirement for AI/ML beam prediction with testability.

### BACKGROUND

It is known for a device to use transmit and receive beams for communication in a communication network.

### BRIEF DESCRIPTION OF THE DRAWINGS

The foregoing aspects and other features are explained in the following description, taken in connection with the accompanying drawings.

FIG. 1 is a flow chart of the herein described solution.

FIG. 2 shows signaling for measurements requirements testing between the TE and UE in command mode.

FIG. 3 shows signaling for measurements requirements testing between the TE and UE, when the TE and UE are in emulating mode.

FIG. 4 is a block diagram of one possible and non-limiting system in which the example embodiments may be practiced.

FIG. 5 is an example apparatus configured to implement the examples described herein.

FIG. 6 shows a representation of an example of non-volatile memory media used to store instructions that implement the examples described herein.

FIG. 7 is an example method, based on the examples described herein.

FIG. 8 is an example method, based on the examples described herein.

### DETAILED DESCRIPTION OF EXAMPLE EMBODIMENTS

To support a new AI/ML-enabled radio interface for the next cellular systems, 3GPP is currently investigating a new study item (RP-213599) for Release 18. AI/ML-based beam management targets spatial and/or time beam prediction for overhead and latency reduction.

The study is to identify areas where AI/ML could improve the performance of air-interface functions. Specification impact will be assessed to improve the overall understanding of what would be required to enable AI/ML techniques for the air interface. The beam management use case is further studied for spatial and/or time beam prediction. The scope of spatial beam prediction (BM-Case1) is to predict the best Tx/Rx beams in different spatial locations. Conversely, time-domain beam predictions (BM-Case2) aim to predict the most likely beam to use for next time instants, e.g., for beam prediction in the spatial domain (BM-Case1).

Accordingly, the examples described herein relate to the 3GPP study item for AI ML techniques in 3GPP (Study on Artificial Intelligence (AI)/Machine Learning (ML) for NR Air Interface RP-213599) with an objective to study the 3GPP framework for AI/ML for the air-interface corresponding to each target use case regarding aspects such as performance, complexity, and potential specification impact. A use case to focus on is beam management, e.g., beam prediction in time, and/or the spatial domain for overhead and latency reduction, and beam selection accuracy improvement [RAN1].

No such test mechanism exists for measurements data of AI/ML based beam management use cases with impacts on specification requirements (such as 3GPP), and impacts on the UE and TE interface.

3GPP is currently studying the NW side and/or UE side model training as well as the model inference for AI/ML beam management. One of the aspects is the data collection for model training/inference. For AI/ML beam management, the measurement accuracy of the measurement quantity such as L1-RSRP needs to be verified.

Thus, the examples described herein relate to the possibility of enhancing performance requirements, tests, use cases, procedures, functionalities, and measurements with AI/ML based methods. Further, the examples described herein relate to improving data quality for data collection for a network side AI/ML model, and improving accuracy specifications for training datasets and training data generation.

Currently L1-RSRP accuracy requirements are specified in 38.133 [3GPP TS 38.133 L1-RSRP measurement requirements] which are suitable for beam management without AI/ML. For AI/ML based beam prediction, the accuracy requirements may vary based on the required performance of the model e.g. the current measurement accuracy requirements for legacy mode may be loose with an L1-RSRP error range of [−6 dB, +6 dB].

Although the NW has configured the input parameters to the UE, there may be further restrictions associated with the provided ML model and the input parameters. Wrong results or input in high error or invalid input parameters may cause inaccurate or invalid predictions.

What has been devised, and what is described herein is a testing framework including some impacts on the interface between the UE and the Test Equipment (TE)/NW in order to verify and validate L1-RSRP measurement requirements in the case when the UE needs to respect different accuracy requirements in different modes of functioning.

The proposed framework consists of following steps:

Step 1: The goal of this step is to ensure that the mode of functionality at the UE side is well known at the TE side. This is achieved either by a command from the TE to the UE to work in a specific mode. For instance, the TE sends a command to the UE to enable the AI/ML based beam management use case. The UE may then confirm the activation of the requested mode. TE can also enforce a certain mode of functionality to the UE by emulating certain radio conditions. The radio conditions while changed in a controlled environment forces a performance degradation/improvement of the activated mode of functioning. For instance, in case of performance degradation, the UE is forced to legacy mode (without AI/ML) by the Life Cycle Management (LCM) procedure of the AI/ML functionality.

Step 2: At this step, after activation of the requested mode, the UE starts measurements guaranteeing the required accuracy for the used mode.

Step 3: At this step, the UE reports the measurements to the TE/NW.

Step 4: The TE/NW, which is already aware of the mode used at the UE side, either by the command sent to the UE or by emulating the radio conditions suitable to a specific mode, selects the correspond accuracy target for the configured mode.

Step 5: Finally, the TE verifies if the accuracy target for the configured mode has been achieved or not. The measurement accuracy requirements for L1-RSRP are validated in case the accuracy targets for both legacy and AI/ML modes are validated for the corresponding configuration.

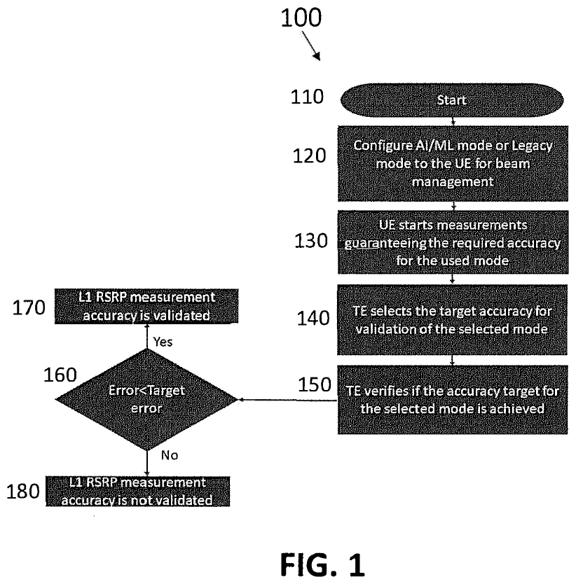

FIG. 1 shows a flow chart of the herein described method 100 that implements the solution. At 110, the method starts. At 120, the UE 10 is configured (e.g. by the NW or TE (where the NW or TE corresponds to either item 202, gNB 70, or core network 90 having one or more network functions 99)) with an AI/ML mode or a legacy mode for beam management. At 130, the UE starts measurements guaranteeing the required accuracy for the used mode. At 140, the TE selects the target accuracy for validation of the selected mode. At 150, the TE verifies if the accuracy target for the selected mode is achieved. At 160, it is determined whether the error is less than a target error. If at 160 it is determined that the error is less than the target error (e.g. “Yes”), the method transitions to 170. If at 160 it is determined that the error is greater than or equal to the target error (e.g. “No”), the method transitions to 180. At 170, L1 RSRP measurement accuracy is validated. At 180, L1 RSRP measurement accuracy is not validated.

Accordingly, described herein is a testing framework for measurement accuracy requirements for AI/ML based functionality for a beam management use-case, e.g., AI/ML beam management for Top-K (K being a number e.g. an integer) beam prediction in spatial domain/time domain, AI/ML beam management for L1-RSRP prediction in spatial domain, and AI/ML beam management for Tx-Rx beam-pairs prediction.

We assume that the UE performs training and inference to obtain the prediction. For the AI/ML beam management use-case and AI/ML positioning use-case, the UE could use L1-RSRP measurements as input for the neural network to perform prediction. The measurement data needs to be accurate enough for high prediction accuracy.

The measurements requirement for AI/ML beam prediction, e.g., the measurements accuracy requirements for AI/ML beam management should be tighter than the measurements accuracy requirements for the legacy mode.

The measurement accuracy requirements of AI/ML beam prediction are to be the same for different functionalities-based AI/ML beam prediction, e.g., although the UE performs Top-K beam prediction in spatial domain or Top-1 beam prediction in time domain or Top-K DL Tx-Rx beam-pairs prediction, the measurement accuracy requirements would be the same as long as the UE operates in AI/ML beam prediction mode.

In one embodiment, the measurements accuracy requirements for different use-cases might require different accuracy requirements, e.g., for L1-RSRP measurements accuracy for AI/ML beam management may have a different requirement than L1-RSRP measurements accuracy for AI/ML positioning use-case.

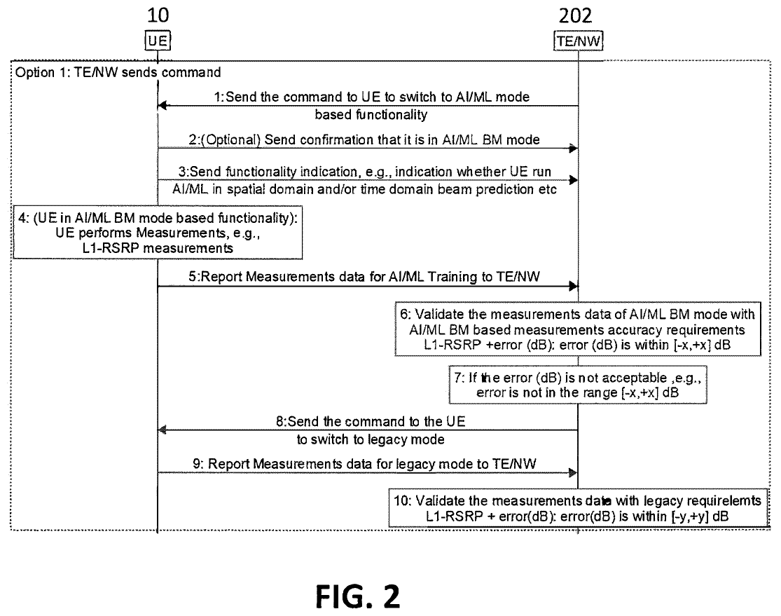

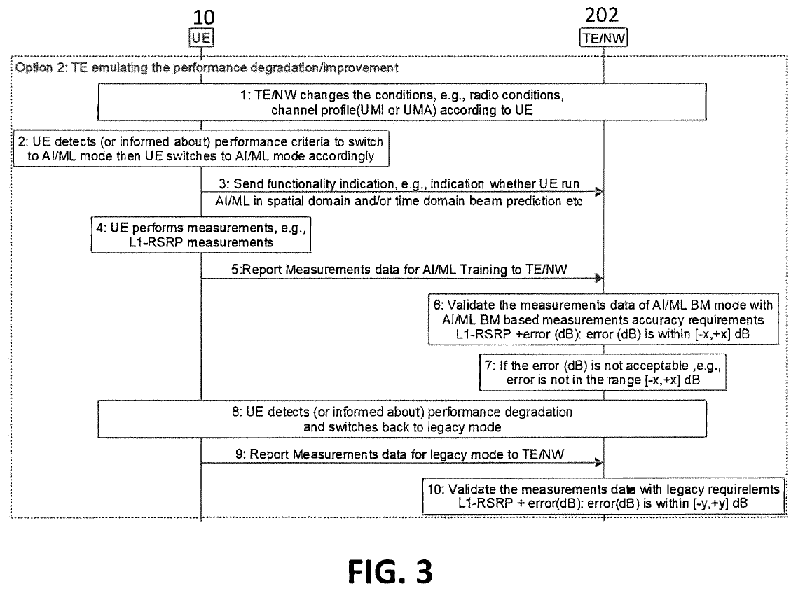

The measurements requirement and testing mechanism are proposed in two main aspects as illustrated in FIG. 2 and FIG. 3. In FIG. 2, TE-UE are in command mode, where the test equipment (TE) 202 (or NW 70, 99) can send the command to UE 10, e.g., TE 202 or NW (70, 99) can send the command to UE 10 to operate in AI/ML BM mode or to switch UE to be in legacy mode, if the L1-RSRP measurements error is higher than the AI/ML BM measurements requirement.

In one embodiment, TE 202 or NW (70, 99) can send the command to UE 10 to operate in AI/ML positioning mode or to switch UE to be in legacy mode, if the L1-RSRP measurements error is higher than AI/ML positioning measurements requirement.

In FIG. 3, the TE-UE are in emulating mode, when UE 10 is in AI/ML BM mode, and the measurements dataset is collected under a certain radio conditions environment (e.g., urban macro (UMa) radio conditions with a low/static mobility UE, or UMa radio conditions with a high mobility UE or urban micro (UMi). The TE 202 (or NW 70, 99) emulates the radio conditions from the UE and can switch the UE to operate in legacy mode, if the measurements requirements are not satisfied.

Note that: The ground truth of L1-RSRP values is known at the NW, according to 3GPP TS 38.133. In clause 10.1.19 and 10.1.20 in [3GPP TS 38.133 L1-RSRP measurement requirements], the L1-RSRP accuracy requirements for FR1 and FR2 are described, respectively. For FR1, the SSB based L1-RSRP requirements and CSI-RS based L1-RSRP requirements are given in 10.1.19.1 and 10.1.19.2, respectively. For FR2, the SSB based L1-RSRP requirements and CSI-RS based L1-RSRP requirements are given in 10.1.20.1, and 10.1.20.2, respectively. Accordingly, the minimum requirements of L1-RSRP and the maximum requirements are defined (for legacy).

The details of the measurements requirement and testing mechanism when the TE-UE are in command mode are shown in FIG. 2. The measurements requirement and testing mechanism when the TE-UE are in emulating mode are shown in FIG. 3.

The details of option 1 (TE/NW sends command) shown in FIG. 2 are described as follows:
1: The TE or NW configures a functionality and sends the command to UE 10 switching to the configured AI/ML functionality-based operation. The functionality-based AI/ML beam management could be, e.g., spatial domain Top-K or Top-1 beam IDs prediction, spatial domain L1-RSRP prediction, and/or time domain beam ID prediction and/or DL Tx-Rx beam-pairs prediction.
2: (Optional) The UE might be configured to send the confirmation that it runs in a functionality-based mode/operation (e.g., AI/ML beam management mode).
3: UE sends the details on the functionality of running the mode (e.g., the indication whether UE performs Top-K or Top-1 beam IDs prediction in spatial domain and/or time domain, or the UE performs L1-RSRP prediction in spatial domain and/or time domain, or the UE performs DL Tx-Rx beam pairs-prediction).
4: The UE, in AI/ML BM mode with respect to its corresponding functionality, performs measurements, e.g., L1-RSRP measurements.
5: The UE reports AI/ML measurements of AI/ML BM based functionality to the TE/NW.
6. The TE or NW validates the measurements data of AI/ML BM mode based functionality, with AI/ML BM measurements accuracy requirements, e.g., L1-RSRP+error (dB): error(dB) needs to be in the range of [−x, +x] dB.

Note that: The TE 202 or NW (70, 99) knows the L1-RSRP measurements accuracy (ground truth), 3GPP TS 38.133. In clause 10.1.19 and 10.1.20, as mentioned in the earlier paragraph. Therefore, the TE or NW can validate the L1-RSRP+error (dB) with the ground truth of L1-RSRP.
7. If the error (dB) is not in the range of [−x,+x] dB, it means the measurement dataset fails the test.
8. The TE sends a command to UE to switch to legacy mode.
9. The UE then switches to legacy mode, and reports measurement data for legacy mode to TE/NW.
10. The TE/NW validates measurements data with legacy requirements, e.g., L1-RSRP+error(dB), where error(dB) needs to be in the range [−y,+y] dB.

Note that: the error range [−x,+x] dB for AI/ML BM use-case corresponding functionality is to be tighter than legacy mode [−y,+y] dB.

The details of Option 2 (TE emulating the performance degradation/improvement) shown in FIG. 3 are described as follows:
1: The TE/NW (202, 70, 99) would change the radio conditions environment according to the UE 10, e.g., TE/NW changes the channel profile, e.g., (UMI or UMA conditions with the UEs mobility).
2: The UE detects the performance criteria switching to AI/ML mode (AI/ML BM mode), and UE switches to the AI/ML mode accordingly.
3: UE sends the details on the functionality of running the mode (e.g., the indication whether UE performs Top-K or Top-1 beam IDs prediction in spatial domain and/or time domain, or UE performs L1-RSRP prediction in spatial domain and/or time domain, or UE performs DL Tx-Rx beam pairs-prediction).
4: The UE, in AI/ML BM mode with respect to its corresponding functionality, performs measurements, e.g., L1-RSRP measurements.
5. The UE reports AI/ML measurements of the functionality to the TE/NW.
6: The TW or NW validates the measurements data of AI/ML BM mode based functionality, with AI/ML BM measurements accuracy requirements, e.g., L1-RSRP+error (dB): error(dB) needs to be in the range of [−x, +x] dB.
7: If the error (dB) is not in the range of [−x,+x] dB, it means the measurement dataset fails the test.
8: Then, the UE detects (or is informed about) the performance degradation and the UE switches back to legacy mode.
9: Then, the UE reports measurements data for legacy mode to TE or NW.
10: The TE/NW validates measurements data with legacy requirements, e.g., L1-RSRP+error(dB), where error(dB) needs to be in the range [−y,+y] dB.

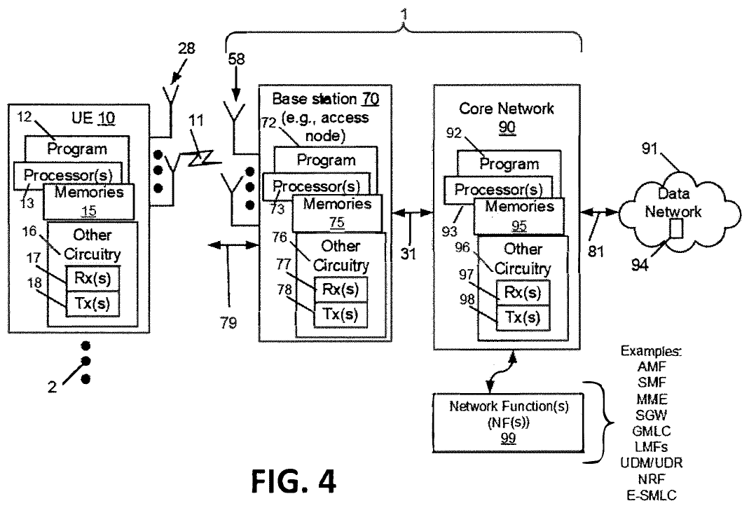

FIG. 4 shows a block diagram of one possible and non-limiting example of a cellular network 1 that is connected to a user equipment (UE) 10. A number of network elements are shown in the cellular network of FIG. 4: a base station 70; and a core network 90.

In FIG. 4, a user equipment (UE) 10 is in wireless communication via radio link 11 with the base station 70 of the cellular network 1. A UE 10 is a wireless communication device, such as a mobile device, that is configured to access a cellular network. The UE 10 is illustrated with one or more antennas 28. The ellipses 2 indicate there could be multiple UEs 10 in wireless communication via radio links with the base station 70. The UE 10 includes one or more processors 13, one or more memories 15, and other circuitry 16. The other circuitry 16 includes one or more receivers (Rx(s)) 17 and one or more transmitters (Tx(s)) 18. A program 12 is used to cause the UE 10 to perform the operations described herein. For a UE 10, the other circuitry 16 could include circuitry such as for user interface elements (not shown) like a display.

The base station 70, as a network element of the cellular network 1, provides the UE 10 access to cellular network 1 and to the data network 91 via the core network 90 (e.g., via a user plane function (UPF) of the core network 90). The base station 70 is illustrated as having one or more antennas 58. In general, the base station 70 is referred to as RAN node 70 herein. An example of a RAN node 70 is a gNB. There are, however, many other examples of RAN nodes including an eNB (LTE base station) or transmission reception point (TRP). The base station 70 includes one or more processors 73, one or more memories 75, and other circuitry 76. The other circuitry 76 includes one or more receivers (Rx(s)) 77 and one or more transmitters (Tx(s)) 78. A program 72 is used to cause the base station 70 to perform the operations described herein.

It is noted that the base station 70 may instead be implemented via other wireless technologies, such as Wi-Fi (a wireless networking protocol that devices use to communicate without direct cable connections). In the case of Wi-Fi, the link 11 could be characterized as a wireless link.

Two or more base stations 70 communicate using, e.g., link(s) 79. The link(s) 79 may be wired or wireless or both and may implement, e.g., an Xn interface for fifth generation (5G), an X2 interface for LTE, or other suitable interface for other standards.

The cellular network 1 may include a core network 90, as a third illustrated element or elements, that may include core network functionality, and which provide connectivity via a link or links 81 with a data network 91, such as a telephone network and/or a data communications network (e.g., the Internet). The core network 90 includes one or more processors 93, one or more memories 95, and other circuitry 96. The other circuitry 96 includes one or more receivers (Rx(s)) 97 and one or more transmitters (Tx(s)) 98. A program 92 is used to cause the core network 90 to perform the operations described herein.

The core network 90 could be a 5GC (5G core network). The core network 90 can implement or comprise multiple network functions (NF(s)) 99, and the program 92 may comprise one or more of the NFs 99. A 5G core network may use hardware such as memory and processors and a virtualization layer. It could be a single standalone computing system, a distributed computing system, or a cloud computing system. The NFs 99, as network elements, of the core network could be containers or virtual machines running on the hardware of the computing system(s) making up the core network 90.

Core network functionality for 5G may include access and mobility management functionality that is provided by a network function 99 such as an access and mobility management function (AMF(s)), session management functionality that is provided by a network function such as a session management function (SMF). Core network functionality for access and mobility management in an LTE network may be provided by an MME (Mobility Management Entity) and/or SGW (Serving Gateway) functionality, which routes data to the data network. Many others are possible, as illustrated by the examples in FIG. 4: AMF; SMF; MME; SGW; gateway mobile location center (GMLC); location management functions (LMFs); unified data management (UDM); unified data repository (UDR); network repository function (NRF); and/or evolved serving mobile location center (E-SMLC). These are merely exemplary core network functionality that may be provided by the core network 90, and note that both 5G and LTE core network functionality might be provided by the core network 90. The radio access network (RAN) node 70 is coupled via a backhaul link 31 to the core network 90. The RAN node 70 and the core network 90 may include an NG interface for 5G, or an S1 interface for LTE, or other suitable interface for other radio access technologies for communicating via the backhaul link 31.

In the data network 91, there is a computer-readable medium 94. The computer-readable medium 94 contains instructions that, when downloaded and installed into the memories 15, 75, or 95 of the corresponding UE 10, base station 70, and/or core network element(s) 90, and executed by processor(s) 13, 73, or 93, cause the respective device to perform corresponding actions described herein. The computer-readable medium 94 may be implemented in other forms, such as via a compact disc or memory stick.

The programs 12, 72, and 92 contain instructions stored by corresponding one or more memories 15, 75, or 95. These instructions, when executed by the corresponding one or more processors 13, 73, or 93, cause the corresponding apparatus 10, 70, or 90, to perform the operations described herein. The computer readable memories 15, 75, or 95 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 15, 75, and 95 may be means for performing storage functions. The processors 13, 73, and 93, may be of any type suitable to the local technical environment, and may include one or more of general-purpose computers, special purpose computers, microprocessors, digital signal processors (DSPs) and processors based on a multi-core processor architecture, as non-limiting examples. The processors 13, 73, and 93 may be means for causing their respective apparatus to perform functions, such as those described herein.

The receivers 17, 77, and 97, and the transmitters 18, 78, and 98 may implement wired or wireless interfaces. The receivers and transmitters may be grouped together as transceivers.

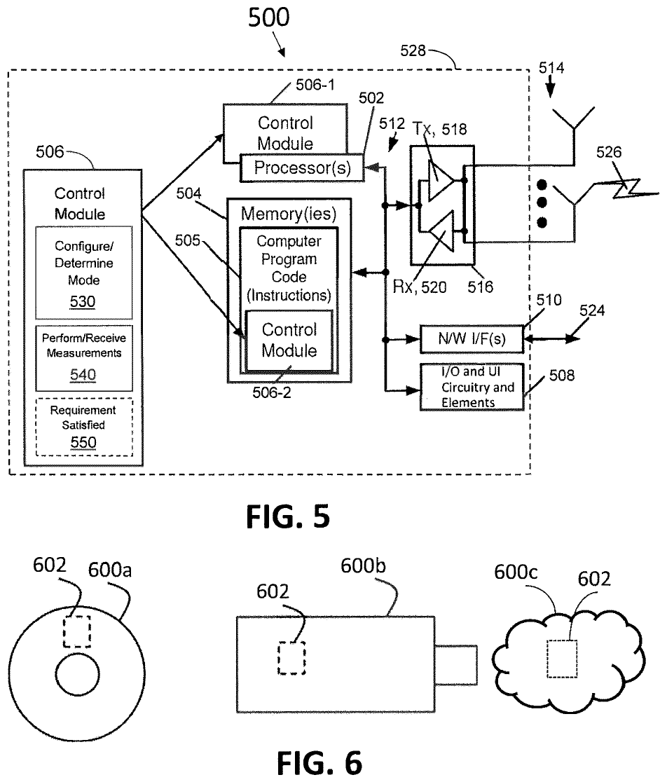

FIG. 5 is an example apparatus 500, which may be implemented in hardware, configured to implement the examples described herein. The apparatus 500 comprises at least one processor 502 (e.g. an FPGA and/or CPU), one or more memories 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein, including a measurement accuracy requirement for AI/ML beam prediction with testability. The memory 504 may be a non-transitory memory, a transitory memory, a volatile memory (e.g. RAM), or a non-volatile memory (e.g. ROM). Configure or determine mode 530 and perform or receive measurements 540 of the control module implement the herein described aspects related to a measurement accuracy requirement for AI/ML beam prediction with testability. Optionally included requirement satisfied 550 is configured to determine whether a measurement accuracy requirement is satisfied (e.g. requirement satisfied 550 is performed by TE/NW 202, 70, 99).

The apparatus 500 includes a display and/or I/O interface 508, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique including via one or more links 524. The link(s) 524 may be the link(s) 11 and/or 79 and/or 31 and/or 81 from FIG. 5. The link(s) 11 and/or 79 and/or 31 and/or 81 from FIG. 5 may also be implemented using transceiver(s) 516 and corresponding wireless link(s) 526. The communication I/F(s) 510 may comprise one or more transmitters or one or more receivers.

The transceiver 516 comprises one or more transmitters 518 and one or more receivers 520. The transceiver 516 and/or communication I/F(s) 510 may comprise standard well-known components such as an amplifier, filter, frequency-converter, (de)modulator, and encoder/decoder circuitries and one or more antennas, such as antennas 514 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the one or more processors 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the one or more processors 502. For instance, the one or more memories 504 store instructions that, when executed by the one or more processors 502, cause the apparatus 500 to perform one or more of the operations as described herein. Furthermore, the one or more processors 502, the one or more memories 504, and example algorithms (e.g., as flowcharts and/or signaling diagrams), encoded as instructions, programs, or code, are means for causing performance of the operations described herein.

The apparatus 500 to implement the functionality of control 506 may be UE 10, base station 70 (e.g. gNB 70), or core network 90 including the one or more network functions 99. Thus, processor 502 may correspond to processor(s) 13, processor(s) 73 and/or processor(s) 93, memory 504 may correspond to one or more memories 15, one or more memories 75 and/or one or more memories 95, computer program code 505 may correspond to program 12, program 72, or program 92, communication I/F(s) 510 and/or transceiver 516 may correspond to other circuitry 16, other circuitry 76, or other circuitry 96, and antennas 514 may correspond to antennas 28 or antennas 58. Apparatus 500 may also correspond to test equipment 202.

Alternatively, apparatus 500 and its elements may not correspond to either of UE 10, base station 70, or core network and their respective elements including one or more network functions 99, as apparatus 500 may be part of a self-organizing/optimizing network (SON) node or other node, such as a node in a cloud.

The apparatus 500 may also be distributed throughout the network (e.g. 91) including within and between apparatus 500 and any network element (such as core network 90 and/or the base station 70 and/or the UE 10).

Interface 512 enables data communication and signaling between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control 506 may comprise object-oriented software configured to pass data or messages between objects within computer program code 505. The apparatus 500 need not comprise each of the features mentioned, or may comprise other features as well. The various components of apparatus 500 may at least partially reside in a common housing 528, or a subset of the various components of apparatus 500 may at least partially be located in different housings, which different housings may include housing 528.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the steps of the methods described herein.

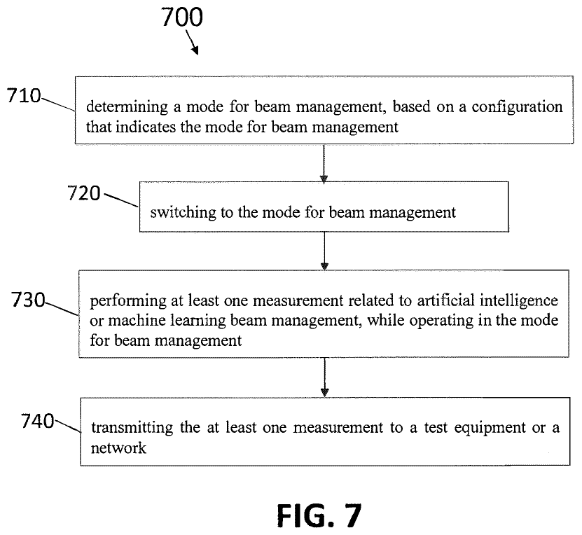

FIG. 7 is an example method 700, based on the example embodiments described herein. At 710, the method includes determining a mode for beam management, based on a configuration that indicates the mode for beam management. At 720, the method includes switching to the mode for beam management. At 730, the method includes performing at least one measurement related to artificial intelligence or machine learning beam management, while operating in the mode for beam management. At 740, the method includes transmitting the at least one measurement to a test equipment or a network. Method 700 may be performed with UE 10 or apparatus 500.

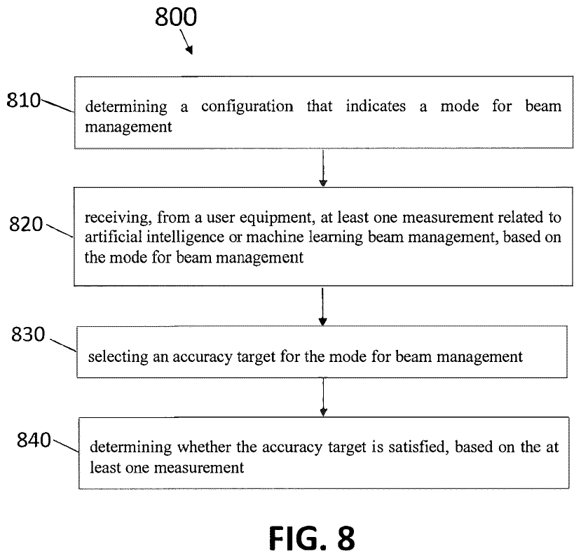

FIG. 8 is an example method 800, based on the example embodiments described herein. At 810, the method includes determining a configuration that indicates a mode for beam management. At 820, the method includes receiving, from a user equipment, at least one measurement related to artificial intelligence or machine learning beam management, based on the mode for beam management. At 830, the method includes selecting an accuracy target for the mode for beam management. At 840, the method includes determining whether the accuracy target is satisfied, based on the at least one measurement. Method 800 may be performed with test equipment 202, base station 70, network function 99 performed with a network entity, or apparatus 500.

The following examples are provided and described herein.

Example 1. An apparatus including: at least one processor; and at least one memory storing instructions that, when executed by the at least one processor, cause the apparatus at least to: determine a mode for beam management, based on a configuration that indicates the mode for beam management; switch to the mode for beam management; perform at least one measurement related to artificial intelligence or machine learning beam management, while operating in the mode for beam management; and transmit the at least one measurement to a test equipment or a network.

Example 2. The apparatus of example 1, wherein the mode comprises one of: an artificial intelligence or machine learning mode, or a legacy mode.

Example 3. The apparatus of any of examples 1 to 2, wherein the mode comprises artificial intelligence or machine learning operation for at least one of: spatial domain beam identifier prediction for a top beam, or spatial domain beam identifier prediction for a number of top beams, or spatial domain layer 1 reference signal received power prediction, or time domain beam identifier prediction for a top beam, or time domain beam identifier prediction for a number of top beams, or time domain layer 1 reference signal received power prediction, or downlink transmit receive beam pairs prediction.

Example 4. The apparatus of any of examples 1 to 3, wherein the instructions, when executed by the at least one processor, cause the apparatus at least to: receive, from the test equipment or the network, a command for the apparatus to switch to an artificial intelligence or machine learning beam management mode, wherein the mode for beam management comprises the artificial intelligence or machine learning beam management mode.

Example 5. The apparatus of any of examples 1 to 4, wherein the instructions, when executed by the at least one processor, cause the apparatus at least to: detect a change in a radio conditions environment; and determine the mode for beam management based on the change in the radio conditions environment.

Example 6. The apparatus of example 5, wherein the instructions, when executed by the at least one processor, cause the apparatus at least to: determine the mode for beam management to be an artificial intelligence or machine learning mode, when the change in the radio conditions environment comprises a performance improvement.

Example 7. The apparatus of any of examples 5 to 6, wherein the instructions, when executed by the at least one processor, cause the apparatus at least to: determine the mode for beam management to be a legacy mode, when the change in the radio conditions environment comprises a performance degradation.

Example 8. The apparatus of any of examples 1 to 7, wherein the at least one measurement is used as input for beam prediction using artificial intelligence or machine learning.

Example 9. The apparatus of any of examples 1 to 8, wherein the at least one measurement comprises at least one of: a layer 1 reference signal received power measurement, or one or more positions of a user equipment, or one or more transmission beam angles, or non line of sight (nLoS) information, or a non line of sight (nLoS) indication, or line of sight (LoS) information, or a line of sight (LoS) indication.

Example 10. The apparatus of any of examples 1 to 9, wherein a measurement accuracy requirement for an artificial intelligence or machine learning mode for beam management is satisfied when an error associated with the at least one measurement is within an artificial intelligence or machine learning beam management mode error bound, or within a layer 1 reference signal received power (L1-RSRP) measurements error bound.

Example 11. The apparatus of any of examples 1 to 10, wherein a measurement accuracy requirement for a legacy mode for beam management is satisfied when an error associated with the at least one measurement is within a legacy mode error bound, or within a layer 1 reference signal received power (L1-RSRP) error bound.

Example 12. The apparatus of any of examples 1 to 11, wherein the instructions, when executed by the at least one processor, cause the apparatus at least to: transmit, to the test equipment or the network, an indication that the apparatus is operating in the mode for beam management.

Example 13. The apparatus of any of examples 1 to 12, wherein the at least one measurement satisfies or does not satisfy a measurement accuracy requirement.

Example 14. The apparatus of example 13, wherein the measurement accuracy requirement comprises a value.

Example 15. The apparatus of example 14, wherein: the measurement accuracy requirement is satisfied for an artificial intelligence or machine learning mode for beam management, when the at least one measurement is within a first tolerance value of the value; and the measurement accuracy requirement is satisfied for a legacy mode for beam management, when the at least one measurement is within a second tolerance value of the value.

Example 16. The apparatus of example 15, wherein the first tolerance value is less than the second tolerance value.

Example 17. The apparatus of any of examples 15 to 16, wherein the first tolerance value is greater than the second tolerance value.

Example 18. The apparatus of any of examples 1 to 17, wherein the instructions, when executed by the at least one processor, cause the apparatus at least to: train an artificial intelligence or machine learning model for beam management, based on the at least one measurement.

Example 19. The apparatus of any of examples 1 to 18, wherein the instructions, when executed by the at least one processor, cause the apparatus at least to: receive, from the test equipment or the network, an indication that the at least one measurement satisfies a measurement accuracy requirement.

Example 20. The apparatus of any of examples 1 to 19, wherein the instructions, when executed by the at least one processor, cause the apparatus at least to: receive, from the test equipment or the network, an indication to switch to the mode for beam management, based on whether the at least one measurement satisfies a measurement accuracy requirement.

Example 21. An apparatus including: at least one processor; and at least one memory storing instructions that, when executed by the at least one processor, cause the apparatus at least to: determine a configuration that indicates a mode for beam management; receive, from a user equipment, at least one measurement related to artificial intelligence or machine learning beam management, based on the mode for beam management; select an accuracy target for the mode for beam management; and determine whether the accuracy target is satisfied, based on the at least one measurement.

Example The apparatus of example 21, wherein the mode comprises one of: an artificial intelligence or machine learning mode, or a legacy mode.

Example 23. The apparatus of any of examples 21 to 22, wherein the mode comprises artificial intelligence or machine learning operation for at least one of: spatial domain beam identifier prediction for a top beam, or spatial domain beam identifier prediction for a number of top beams, or spatial domain layer 1 reference signal received power prediction, or time domain beam identifier prediction for a top beam, or time domain beam identifier prediction for a number of top beams, or time domain layer 1 reference signal received power prediction, or downlink transmit receive beam pairs prediction.

Example 24. The apparatus of any of examples 21 to 23, wherein the instructions, when executed by the at least one processor, cause the apparatus at least to: transmit, to the user equipment, a command for the user equipment to switch to an artificial intelligence or machine learning beam management mode, wherein the mode for beam management comprises the artificial intelligence or machine learning beam management mode.

Example 25. The apparatus of any of examples 21 to 24, wherein the instructions, when executed by the at least one processor, cause the apparatus at least to: change a radio conditions environment based on the user equipment; wherein the configuration that indicates the mode for beam management is based on the change in the radio conditions environment based on the user equipment.

Example 26. The apparatus of example 25, wherein the configuration indicates the mode for beam management to be an artificial intelligence or machine learning mode, when the change in the radio conditions environment comprises a performance improvement.

Example 27. The apparatus of any of examples 25 to 26, wherein the configuration indicates the mode for beam management to be a legacy mode, when the change in the radio conditions environment comprises a performance degradation.

Example 28. The apparatus of any of examples 21 to 27, wherein the at least one measurement is used as input for beam prediction using artificial intelligence or machine learning.

Example 29. The apparatus of any of examples 21 to 28, wherein the at least one measurement comprises at least one of: a layer 1 reference signal received power measurement, or one or more positions of a user equipment, or one or more transmission beam angles or non line of sight (nLoS) information, or a non line of sight (nLoS) indication, or line of sight (LoS) information, or a line of sight (LoS) indication.

Example 30. The apparatus of any of examples 21 to 29, wherein the instructions, when executed by the at least one processor, cause the apparatus at least to: determine measurement accuracy requirements for an artificial intelligence or machine learning mode for beam management; and determine that a measurement accuracy requirement for the artificial intelligence or machine learning mode is satisfied, when an error associated with the at least one measurement is within an artificial intelligence or machine learning beam management mode error bound or within a layer 1 reference signal received power (L1-RSRP) measurements error bound.

Example 31. The apparatus of any of examples 21 to 30, wherein the instructions, when executed by the at least one processor, cause the apparatus at least to: determine measurement accuracy requirements for a legacy mode for beam management; and determine that a measurement accuracy requirement for the legacy mode for beam management is satisfied, when an error associated with the at least one measurement is within a legacy mode error bound, or within a layer 1 reference signal received power (L1-RSRP) error bound.

Example 32. The apparatus of any of examples 21 to 31, wherein the instructions, when executed by the at least one processor, cause the apparatus at least to: receive, from the user equipment, an indication that the user equipment is operating in the mode for beam management.

Example 33. The apparatus of any of examples 21 to 32, wherein the instructions, when executed by the at least one processor, cause the apparatus at least to: determine whether the at least one measurement satisfies a measurement accuracy requirement.

Example 34. The apparatus of example 33, wherein the measurement accuracy requirement comprises a value.

Example 35. The apparatus of example 34, wherein the instructions, when executed by the at least one processor, cause the apparatus at least to: determine that the measurement accuracy requirement is satisfied for an artificial intelligence or machine learning mode for beam management, when the at least one measurement is within a first tolerance value of the value; and determine that the measurement accuracy requirement is satisfied for a legacy mode for beam management, when the at least one measurement is within a second tolerance value of the value.

Example 36. The apparatus of example 35, wherein the first tolerance value is less than the second tolerance value.

Example 37. The apparatus of any of examples 35 to 36, wherein the first tolerance value is greater than the second tolerance value.

Example 38. The apparatus of any of examples 21 to 37, wherein the instructions, when executed by the at least one processor, cause the apparatus at least to: train an artificial intelligence or machine learning model for beam management, based on the at least one measurement.

Example 39. The apparatus of any of examples 21 to 38, wherein the instructions, when executed by the at least one processor, cause the apparatus at least to: determine whether the at least one measurement satisfies a measurement accuracy requirement; and transmit, to the user equipment, an indication that the at least one measurement satisfies a measurement accuracy requirement.

Example 40. The apparatus of any of examples 21 to 39, wherein the instructions, when executed by the at least one processor, cause the apparatus at least to: determine whether the at least one measurement satisfies a measurement accuracy requirement; and transmit, to the user equipment, an indication to switch to the mode for beam management, based on whether the at least one measurement satisfies a measurement accuracy requirement.

Example 41. A method including: determining a mode for beam management, based on a configuration that indicates the mode for beam management; switching to the mode for beam management; performing at least one measurement related to artificial intelligence or machine learning beam management, while operating in the mode for beam management; and transmitting the at least one measurement to a test equipment or a network.

Example 42. A method including: determining a configuration that indicates a mode for beam management; receiving, from a user equipment, at least one measurement related to artificial intelligence or machine learning beam management, based on the mode for beam management; selecting an accuracy target for the mode for beam management; and determining whether the accuracy target is satisfied, based on the at least one measurement.

Example 43. An apparatus including: means for determining a mode for beam management, based on a configuration that indicates the mode for beam management; means for switching to the mode for beam management; means for performing at least one measurement related to artificial intelligence or machine learning beam management, while operating in the mode for beam management; and means for transmitting the at least one measurement to a test equipment or a network.

Example 44. An apparatus including: means for determining a configuration that indicates a mode for beam management; means for receiving, from a user equipment, at least one measurement related to artificial intelligence or machine learning beam management, based on the mode for beam management; means for selecting an accuracy target for the mode for beam management; and means for determining whether the accuracy target is satisfied, based on the at least one measurement.

Example 45. A non-transitory program storage device readable by a machine, tangibly embodying a program of instructions executable by the machine for performing operations, the operations including: determining a mode for beam management, based on a configuration that indicates the mode for beam management; switching to the mode for beam management; performing at least one measurement related to artificial intelligence or machine learning beam management, while operating in the mode for beam management; and transmitting the at least one measurement to a test equipment or a network.

Example 46. A non-transitory program storage device readable by a machine, tangibly embodying a program of instructions executable by the machine for performing operations, the operations including: determining a configuration that indicates a mode for beam management; receiving, from a user equipment, at least one measurement related to artificial intelligence or machine learning beam management, based on the mode for beam management; selecting an accuracy target for the mode for beam management; and determining whether the accuracy target is satisfied, based on the at least one measurement.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, or the text ‘s’ to in some examples indicate plurality, and may be case insensitive):
3GPP third generation partnership project
4G fourth generation
5G fifth generation
5GC 5G core network
AI artificial intelligence
AMF access and mobility management function
ASIC application-specific integrated circuit
BM beam management
CD compact/computer disc
CPU central processing unit
CSI-RS channel state information reference signal
DL downlink
DSP digital signal processor
DVD digital versatile disc
eNB evolved Node B (e.g., an LTE base station)
EPC evolved packet core
E-SMLC evolved serving mobile location center
FPGA field-programmable gate array
FR frequency range
GMLC gateway mobile location center
gNB base station for 5G/NR, i.e., a node providing NR user plane and control plane protocol terminations towards the UE, and connected via the NG interface to the 5GC
ID identifier
I/F interface
I/O input/output
L1 layer 1
LCM life cycle management
LMF location management function
LoS line of sight
LTE long term evolution (4G)
ML machine learning
MME mobility management entity
NF network function
NG new generation
NG-RAN new generation radio access network
nLoS non-line-of-sight
NR new radio
NRF network repository function
N/W network
NW network
RAM random access memory
RAN radio access network
RAN1 radio layer 1
ROM read-only memory
RP RAN plenary
RSRP reference signal received power
Rx receiver or reception
S1 interface connecting the eNB to the EPC
SGW serving gateway
SMF session management function
SON self-organizing/optimizing network
SSB synchronization signal block, or synchronization signal and physical broadcast channel block
TE test equipment
TRP transmission reception point
TS technical specification
Tx transmitter or transmission
UDM unified data management
UDR unified data repository
UE user equipment (e.g., a wireless, typically mobile device)
UI user interface
UMa urban macro
UMA urban macro
UMi urban micro
UMI urban micro
UPF user plane function
USB universal serial bus
Wi-Fi wireless networking protocol that devices use to communicate without direct cable connections
X2 network interface between RAN nodes and between RAN and the core network
Xn network interface between NG-RAN nodes

What is claimed is:

1. An apparatus comprising:
at least one processor; and
at least one memory storing instructions that, when executed by the at least one processor, cause the apparatus at least to:
determine a mode for beam management, based on a configuration that indicates the mode for beam management;
switch to the mode for beam management;
perform at least one measurement related to artificial intelligence or machine learning beam management, while operating in the mode for beam management; and
transmit the at least one measurement to a test equipment or a network.

2. The apparatus of claim 1, wherein the mode comprises one of:
an artificial intelligence or machine learning mode, or
a legacy mode.

3. The apparatus of claim 1, wherein the mode comprises artificial intelligence or machine learning operation for at least one of:
spatial domain beam identifier prediction for a top beam, or
spatial domain beam identifier prediction for a number of top beams, or
spatial domain layer 1 reference signal received power prediction, or
time domain beam identifier prediction for a top beam, or
time domain beam identifier prediction for a number of top beams, or
time domain layer 1 reference signal received power prediction, or
downlink transmit receive beam pairs prediction.

4. The apparatus of claim 1, wherein the instructions, when executed by the at least one processor, cause the apparatus at least to:
receive, from the test equipment or the network, a command for the apparatus to switch to an artificial intelligence or machine learning beam management mode, wherein the mode for beam management comprises the artificial intelligence or machine learning beam management mode.

5. The apparatus of claim 1, wherein the instructions, when executed by the at least one processor, cause the apparatus at least to:
detect a change in a radio conditions environment; and
determine the mode for beam management based on the change in the radio conditions environment.

6. The apparatus of claim 5, wherein the instructions, when executed by the at least one processor, cause the apparatus at least to:
determine the mode for beam management to be an artificial intelligence or machine learning mode, when the change in the radio conditions environment comprises a performance improvement.

7. The apparatus of claim 5, wherein the instructions, when executed by the at least one processor, cause the apparatus at least to:
determine the mode for beam management to be a legacy mode, when the change in the radio conditions environment comprises a performance degradation.

8. The apparatus of claim 1, wherein the at least one measurement is used as input for beam prediction using artificial intelligence or machine learning.

9. The apparatus of claim 1, wherein the at least one measurement comprises at least one of:
a layer 1 reference signal received power measurement, or
one or more positions of a user equipment, or
one or more transmission beam angles, or
non line of sight (nLoS) information, or
a non line of sight (nLoS) indication, or
line of sight (LoS) information, or
a line of sight (LoS) indication.

10. The apparatus of claim 1, wherein a measurement accuracy requirement for an artificial intelligence or machine learning mode for beam management is satisfied when an error associated with the at least one measurement is within an artificial intelligence or machine learning beam management mode error bound, or within a layer 1 reference signal received power (L1-RSRP) measurements error bound.

11. The apparatus of claim 1, wherein a measurement accuracy requirement for a legacy mode for beam management is satisfied when an error associated with the at least one measurement is within a legacy mode error bound, or within a layer 1 reference signal received power (L1-RSRP) error bound.

12. The apparatus of claim 1, wherein the instructions, when executed by the at least one processor, cause the apparatus at least to:
transmit, to the test equipment or the network, an indication that the apparatus is operating in the mode for beam management.

13. The apparatus of claim 1, wherein the at least one measurement satisfies or does not satisfy a measurement accuracy requirement.

14. The apparatus of claim 13, wherein the measurement accuracy requirement comprises a value.

15. The apparatus of claim 14, wherein:
the measurement accuracy requirement is satisfied for an artificial intelligence or machine learning mode for beam management, when the at least one measurement is within a first tolerance value of the value; and
the measurement accuracy requirement is satisfied for a legacy mode for beam management, when the at least one measurement is within a second tolerance value of the value.

16. The apparatus of claim 15, wherein the first tolerance value is less than the second tolerance value.

17. The apparatus of claim 15, wherein the first tolerance value is greater than the second tolerance value.

18. The apparatus of claim 1, wherein the instructions, when executed by the at least one processor, cause the apparatus at least to:
train an artificial intelligence or machine learning model for beam management, based on the at least one measurement.

19. The apparatus of claim 1, wherein the instructions, when executed by the at least one processor, cause the apparatus at least to:
receive, from the test equipment or the network, an indication that the at least one measurement satisfies a measurement accuracy requirement.

20. The apparatus of claim 1, wherein the instructions, when executed by the at least one processor, cause the apparatus at least to:
receive, from the test equipment or the network, an indication to switch to the mode for beam management, based on whether the at least one measurement satisfies a measurement accuracy requirement.

21. An apparatus comprising:
at least one processor; and
at least one memory storing instructions that, when executed by the at least one processor, cause the apparatus at least to:
determine a configuration that indicates a mode for beam management;
receive, from a user equipment, at least one measurement related to artificial intelligence or machine learning beam management, based on the mode for beam management;
select an accuracy target for the mode for beam management; and
determine whether the accuracy target is satisfied, based on the at least one measurement.

22. A method comprising:
determining a mode for beam management, based on a configuration that indicates the mode for beam management;
switching to the mode for beam management;
performing at least one measurement related to artificial intelligence or machine learning beam management, while operating in the mode for beam management; and
transmitting the at least one measurement to a test equipment or a network.
